(19) United States
(12) Patent Application Publication
(10) Pub. No.: US 2025/0133361 A1
(43) Pub. Date: Apr. 24, 2025

(54) Method of Processing Sound, Sound Processing Apparatus, and Non-Transitory Computer-Readable Storage Medium

(71) Applicant: YAMAHA CORPORATION, Hamamatsu-shi (JP)

(72) Inventors: Futoshi SHIRAKIHARA, Hamamatsu-shi (JP); Ryo MATSUDA, Hamamatsu-shi (JP); Yoshinari NAKAMURA, Hamamatsu-shi (JP); Yuya TAKENAKA, Hamamatsu-shi (JP); Katsumi ISHIKAWA, Hamamatsu-shi (JP); Akio OHTANI, Hamamatsu-shi (JP); Kazuhiko YAMAMOTO, Hamamatsu-shi (JP); Takuya FUJISHIMA, Hamamatsu-shi (JP)

(21) Appl. No.: 19/000,930

(22) Filed: Dec. 24, 2024

Related U.S. Application Data
(63) Continuation of application No. PCT/JP2023/021288, filed on Jun. 8, 2023.

(30) Foreign Application Priority Data
Jul. 4, 2022 (JP) 2022-107675

(51) Int. Cl. H04S 7/00; G06Q 30/04

(52) U.S. Cl. CPC H04S 7/30; G06Q 30/04; H04S 2400/11; H04S 2400/13

(57) ABSTRACT

A method of processing sound includes arranging objects of a plurality of performers in a virtual space. The method also includes receiving a plurality of sound signals respectively corresponding to the plurality of performers. The method also includes obtaining, using a trained model, sound volume adjustment parameters respectively for the plurality of performers. The trained model is trained to learn a relationship between each sound signal, among the plurality of sound signals, that corresponds to each performer of the plurality of performers and each sound volume adjustment parameter, among the sound volume adjustment parameters, that corresponds to the each sound signal. The method also includes adjusting and mixing sound volumes respectively of the plurality of sound signals based on the sound volume adjustment parameters obtained using the trained model.

### CROSS-REFERENCE TO RELATED APPLICATIONS

The present application is a continuation application of International Application No. PCT/JP2023/021288, filed Jun. 8, 2023, which claims priority to Japanese Patent Application No. 2022-107675, filed Jul. 4, 2022. The contents of these applications are incorporated herein by reference in their entirety.

### BACKGROUND

The present disclosure relates to a method of processing sound, a sound processing apparatus, and a non-transitory computer-readable storage medium.

JP2005-128296A discloses an audio mixer that receives audio signals related to a performance from audio mixers B2 and C3 via a network, measures communication delay time between the audio mixers B2 and C3, and mixes the audio signals from the audio mixers B2 and C3 based on the measured communication delay time.

WO/2018/21402 discloses a configuration that enables a smooth transition between a pre-fader and a post-fader by correcting a volume difference between the pre-fader and the post-fader.

JP2021-129145A discloses a configuration that adjusts volume to an appropriate level by measuring impulse response from a speaker to a microphone and performing volume adjustment with indirect sound components taken into consideration.

JP2010-103853A discloses a configuration that performs feedback from a near-end to a far end. Specifically, a near-end direct sound volume measurement result and a distance between a speaker and a microphone are transmitted to the far end. This configuration enables the far-end user to confirm that the far-end user's voice is being correctly amplified.

JP2020-202448A discloses a configuration that adjusts volume of a sound signal received from a far end based on a sound feature value obtained by a near-end microphone. This invention of JP2020-202448A enables volume adjustment with the listening environment taken into consideration.

JP2009-100185A discloses a configuration in which multiple amplifiers are positioned for a plurality of respective performers located at different positions on stage, and a mixer adjusts and supplies a sound signal volume for each amplifier. This configuration enables the mixer recited in JP2009-100185A to collectively adjust the volumes of a plurality of monitor speakers to keep a balance between the volumes.

None of the above-described configurations adjusts the volume balance of a plurality of performers in a virtual space.

It is an object of the present disclosure to provide such a method of processing sound that appropriately adjusts the sound volume balance between a plurality of performers in a virtual space. It is another object of the present disclosure to provide a sound processing apparatus that appropriately adjusts the sound volume balance between a plurality of performers in a virtual space. It is another object of the present disclosure to provide a non-transitory computer-readable storage medium that appropriately adjusts the sound volume balance between a plurality of performers in a virtual space.

### SUMMARY

One aspect is a method of processing sound. The method includes arranging objects of a plurality of performers in a virtual space. The method also includes receiving a plurality of sound signals respectively corresponding to the plurality of performers. The method also includes obtaining, using a trained model, sound volume adjustment parameters respectively for the plurality of performers. The trained model is trained to learn a relationship between each sound signal, among the plurality of sound signals, that corresponds to each performer of the plurality of performers and each sound volume adjustment parameter, among the sound volume adjustment parameters, that corresponds to the each sound signal. The method also includes adjusting and mixing sound volumes respectively of the plurality of sound signals based on the sound volume adjustment parameters obtained using the trained model.

Another aspect is a sound processing apparatus that includes a processor. The processor is configured to arrange objects of a plurality of performers in a virtual space. The processor is also configured to receive a plurality of sound signals respectively corresponding to the plurality of performers. The processor is also configured to obtain, using a trained model, sound volume adjustment parameters respectively for the plurality of performers. The trained model is trained to learn a relationship between each sound signal, among the plurality of sound signals, that corresponds to each performer of the plurality of performers and each sound volume adjustment parameter, among the sound volume adjustment parameters, that corresponds to the each sound signal. The processor is also configured to adjust and mix sound volumes respectively of the plurality of sound signals based on the sound volume adjustment parameters obtained using the trained model.

Another aspect is a non-transitory computer-readable storage medium storing a program. When the program is executed by at least one processor, the program causes the at least one processor to arrange objects of a plurality of performers in a virtual space. The at least one processor is also caused to receive a plurality of sound signals respectively corresponding to the plurality of performers. The at least one processor is also caused to obtain, using a trained model, sound volume adjustment parameters respectively for the plurality of performers. The trained model is trained to learn a relationship between each sound signal, among the plurality of sound signals, that corresponds to each performer of the plurality of performers and each sound volume adjustment parameter, among the sound volume adjustment parameters, that corresponds to the each sound signal. The at least one processor is also caused to adjust and mix sound volumes respectively of the plurality of sound signals based on the sound volume adjustment parameters obtained using the trained model.

A more complete appreciation of the present disclosure and many of the attendant advantages thereof will be readily obtained as the same becomes better understood by reference to the following detailed description when considered in connection with the following figures.

### BRIEF DESCRIPTION OF THE DRAWINGS

FIG. 1 is a block diagram illustrating a configuration of a sound processing system 1;

FIG. 2 is a block diagram illustrating a configuration of a PC 12C;

FIG. 3 is a perspective view of an example of a virtual three-dimensional space R1;

FIG. 4 is a flowchart of operations performed by the PC 12C and a server 30 in training stage;

FIG. 5 is a flowchart of operations performed by the PC 12C in execution stage;

FIG. 6 is a flowchart of operations performed by a PC 12A (or a PC 12B) according to modification 1;

FIG. 7 is a perspective view of an example of the virtual three-dimensional space R1 according to modification 2; and

FIG. 8 is a block diagram illustrating a configuration of a sound processing system 1A according to modification 4.

### DESCRIPTION OF THE EMBODIMENTS

The present specification is applicable to a method of processing sound, a sound processing apparatus, and a non-transitory computer-readable storage medium.

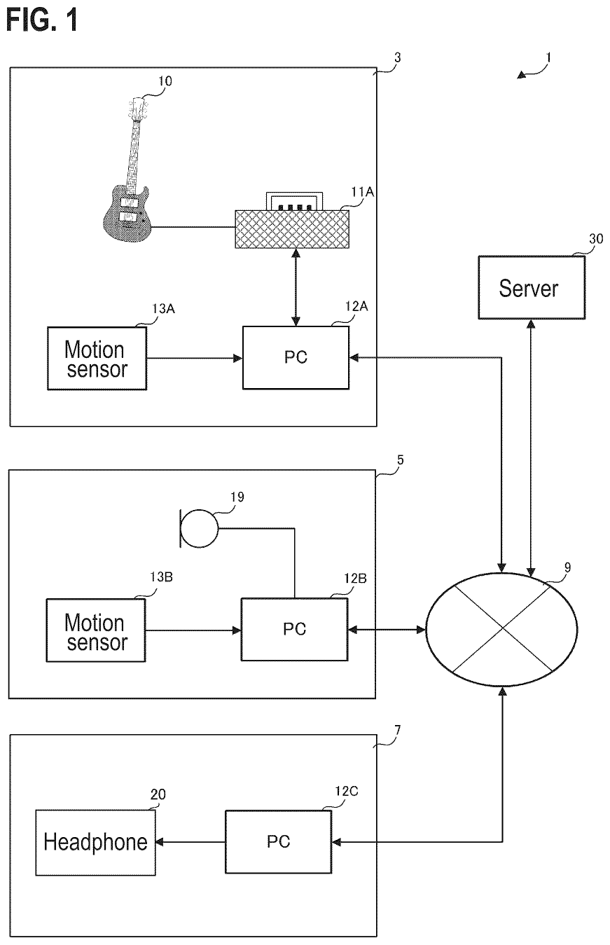

FIG. 1 is a block diagram illustrating a configuration of the sound processing system 1. The sound processing system 1 illustrated in FIG. 1 includes the PC (personal computer) 12A, the PC 12B, the PC 12C, and the server 30. The PC 12A is provided in a first venue 3. The PC 12B is provided in a second venue 5. The PC 12C is provided in a third venue 7. The PC 12A, the PC 12B, the PC 12C, and the server 30 are connected to each other via a network 9. The PC 12A, the PC 12B, and the PC 12C are examples of the sound processing apparatus.

The PC 12A, which is provided in the first venue 3, is connected to a guitar amplifier 11A and the motion sensor 13A. The guitar amplifier 11A is connected to an electric guitar 10.

The electric guitar 10 is an example of the audio appliance. The guitar amplifier 11A is connected to the electric guitar 10 via an audio cable. The guitar amplifier 11A is an example of the audio appliance. The guitar amplifier 11A is connected to the PC 12A via, for example, a USB cable. It will be readily appreciated that the guitar amplifier 11A may be connected to the PC 12A by wireless communication. The electric guitar 10 outputs an analogue sound signal of a performance sound to the guitar amplifier 11A.

The guitar amplifier 11A includes an analogue audio terminal. The guitar amplifier 11A receives the analogue sound signal from the electric guitar 10 via the audio cable. The guitar amplifier 11A converts the received analogue sound signal into a digital sound signal. The guitar amplifier 11A applies various kinds of signal processing, such as effects, to the digital audio signal. The guitar amplifier 11A converts the digital audio signal, after undergoing signal processing, into an analog audio signal. The guitar amplifier 11A amplifies the analogue sound signal. Based on the amplified analog audio signal, the guitar amplifier 11A outputs the performance sound of the electric guitar through the guitar amplifier 11A's built-in speaker. The guitar amplifier 11A also transmits the digital audio signal, after undergoing signal processing, to the PC 12A.

A user of the PC 12A is a performer of the electric guitar 10. The performer of the electric guitar 10 uses the PC 12A to distribute the performance sound of the electric guitar 10 and to cause a 3D model object to serve as a virtual representation of the performer in a virtual space. It is to be noted, however, that the user who distributes a performance sound and the performer may not necessarily be the same person. The PC 12A controls motion data to control motions of the object.

The motion sensor 13A is a sensor that captures motions of a performer. For example, the motion sensor 13A may be an optical, inertial, or image-based sensor, among other types. The motion sensor 13A is connected to the PC 12A via, for example, a USB cable. The PC 12A controls the motion data based on sensor information received from the motion sensor 13A. It will be readily appreciated that the motion sensor 13A may be connected to the PC 12A by wireless communication.

The PC 12A transmits, to the server 30, the digital audio signal of the guitar performance sound received from the guitar amplifier 11A and the motion data that has been controlled based on the sensor information received from the motion sensor 13A.

The PC 12B, which is provided in the second venue 5, is connected to a microphone 19 and a motion sensor 13B.

The microphone 19 is an example of the audio appliance. The microphone 19 is connected to the PC 12B via an audio cable or a USB cable. The PC 12B receives an analogue audio signal from the microphone 19 via an audio cable. The PC 12B converts the received analogue sound signal into a digital sound signal. Another possible example is that the microphone 19 outputs a digital audio signal to the PC 12B via, for example, a USB cable.

A user of the PC 12B is a singer. The singer uses the PC 12B to distribute a singing sound of the singer and to cause a 3D model object to serve as a virtual representation of the singer in a virtual space. The PC 12B controls motion data to control motions of the object. It is to be noted, however, that the user who distributes a singing sound and the singer may not necessarily be the same person.

The motion sensor 13B is a sensor that captures motions of a singer. For example, the motion sensor 13B may be an optical, inertial, or image-based sensor, among other types. The motion sensor 13B is connected to the PC 12B via, for example, a USB cable. The PC 12B controls the motion data based on sensor information received from the motion sensor 13B. It will be readily appreciated that the motion sensor 13B may be connected to the PC 12B by wireless communication.

The PC 12B transmits, to the server 30, the digital sound signal of the singing sound received from the microphone 19 and the motion data that has been controlled based on the sensor information received from the motion sensor 13B.

The PC 12C, which is provided in the third venue 7, is connected to a headphone 20. The headphone 20 is an example of the audio appliance. The user of the PC 12C is a viewer of a virtual musical performance performed by a in a virtual space.

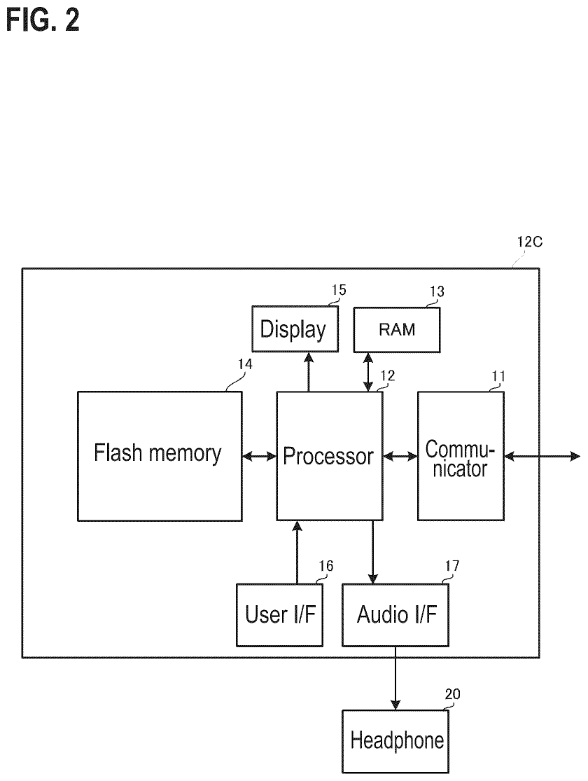

FIG. 2 is a block diagram illustrating a configuration of the PC 12C. The PC 12C is a general-purpose information processor. While FIG. 2 illustrates a configuration of the PC 12C, the PC 12A and the PC 12B are mainly similar in configuration to the configuration illustrated in FIG. 2.

The PC 12C includes a communicator 11, a processor 12, a RAM 13, a flash memory 14, a display 15, a user I/F 16, and an audio I/F 17.

The communicator 11 has a wireless communication function such using as Bluetooth (registered trademark) and Wi-Fi (registered trademark), and has a wired communication function such as using a USB and a LAN.

The display 15 includes an LCD (Liquid Crystal Display) or an OLED (Organic Light-Emitting Diode). The display 15 displays an image output from the processor 12. In this specification, the term “image” is intended to encompass a still image, a sequence of still images, multiple still images spaced throughout time, or images in the form of a video.

The user I/F 16 is an example of an operation piece. The user I/F 16 includes a mouse, a keyboard, or a touch panel. The user I/F 16 receives an operation made by the user. It is to be noted that the touch panel may be laminated over the display 15.

The audio I/F 17 is an interface that includes an analogue audio terminal or a digital audio terminal through which to be connected to an audio appliance. In this embodiment, the audio I/F 17 of the PC 12C is connected to the headphone 20, which is an audio appliance example, to output a sound signal to the headphone 20.

The processor 12 includes a CPU, a DSP, or a SoC (System on a Chip). The processor 12 retrieves a program from the flash memory 14, which is a storage medium, and temporarily stores the program in the RAM 13 to implement various operations. It is to be noted that the program may not necessarily be stored in the flash memory 14. For example, the processor 12 may be downloaded in another device such as a server as necessary and temporarily stored in the RAM 13.

The processor 12 receives a sound signal and motion data from the server 30 via the communicator 11. The sound signal received from the server 30 includes: a first sound signal of the performance sound made by the performer in the first venue 3; and a second sound signal of the singing sound made by the singer in the second venue 5. The motion data received from the server 30 includes a motion of the performer in the first venue 3 and a motion of the singer in the second venue 5. The processor 12 also receives space information, model data, and position information from the server 30 via the communicator 11.

The space information represents the shape of a three-dimensional space corresponding to a live venue, such as a live house or concert hall, and is expressed in three-dimensional coordinates with a specific position as the origin. The space information may be coordinate data based on 3D CAD data of an actual live venue, such as a concert hall, or may be logical coordinate data for a virtual live venue, normalized within a range of 0 to 1.

The model data is three-dimensional CG image data used to construct a 3D model object, and includes a plurality of image components. The model data is specified for each performer. For example, for the performer in the first venue 3, model data that serves as a virtual representation of the performer is specified. The server 30 distributes specified model data.

The position information indicates the position of the model data in a three-dimensional space. The position information is represented by three-dimensional coordinates in the virtual space. The position information may correspond to model data with a fixed location, such as of a speaker or a like appliance, or to model data with a changing location, such as of a performer.

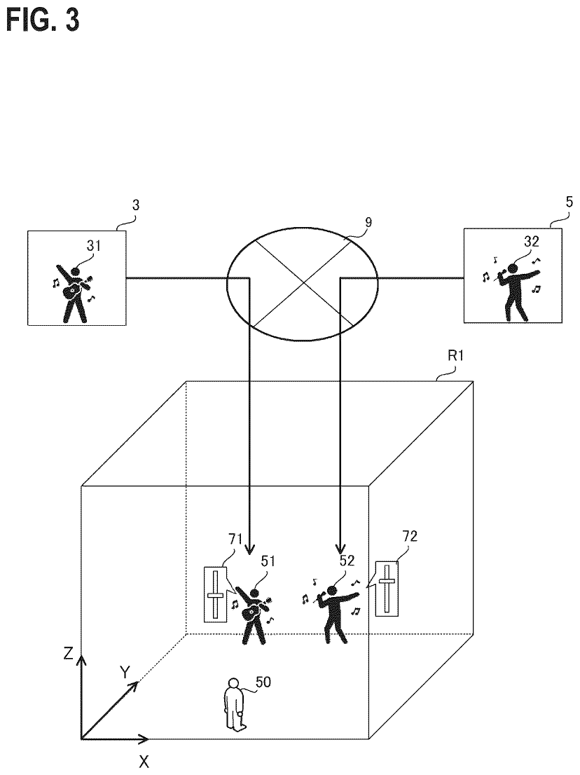

FIG. 3 is a perspective view of an example of the virtual three-dimensional space R1. While the virtual three-dimensional space R1 illustrated in FIG. 3 has a cuboid-shaped space as an example, the shape of the space may take any other form.

Based on the space information and the position information received from the server 30, the processor 12 arranges objects in the virtual three-dimensional space R1, as illustrated in FIG. 3. The processor 12 also sets a position of the user of the PC 12C in the virtual three-dimensional space R1. The position of the user of the PC 12C corresponds to a viewpoint position 50 in the virtual three-dimensional space R1. While FIG. 3 illustrates an overhead view of the virtual three-dimensional space R1, the processor 12 generates an image of the virtual three-dimensional space R1 as viewed from the viewpoint position 50. The processor 12 generates such image by rendering the model data based on the space information, the model data, the position information, the motion data of the objects, and information of the viewpoint position 50. The generated image is displayed on the display 15. This enables the viewer of the PC 12C to view an image of the virtual three-dimensional space R1 as viewed from the set viewpoint position 50. The user of the PC 12C is able to change the viewpoint position 50 in the virtual three-dimensional space R1 via the user I/F 16. The processor 12 generates an image of the virtual three-dimensional space R1 as viewed from the changed viewpoint position 50. This enables the user of the PC 12C to experience a sense of movement within the virtual three-dimensional space R1.

The processor 12 of the PC 12C adjusts and mixes the sound volumes of a plurality of sound signals received from the server 30 to generate a sound signal for, for example, stereo (L, R) channels. In this example, the processor 12 mixes the first sound signal from the first venue 3 and the second sound signal from the second venue 5. The processor 12 outputs the stereo-channels sound signal to the headphone 20 via the audio I/F 17.

It is to be noted that the processor 12 may perform effect processing, such as equalization or reverberation (reverb), on each of the first sound signal and the second sound signal. It is also to be noted that the processor 12 may also perform localization processing on the first sound signal and the second sound signal to position the sound according to the positions of the objects respectively corresponding to the first sound signal and the second sound signal.

The PC 12C obtains sound volume adjustment parameters for a plurality of performers using a trained model. The trained model is trained to learn a relationship between a sound signal corresponding to each performer and a sound volume adjustment parameter corresponding to the sound signal. Then, the PC 12C adjusts and mixes the sound volumes respectively of the plurality of sound signals.

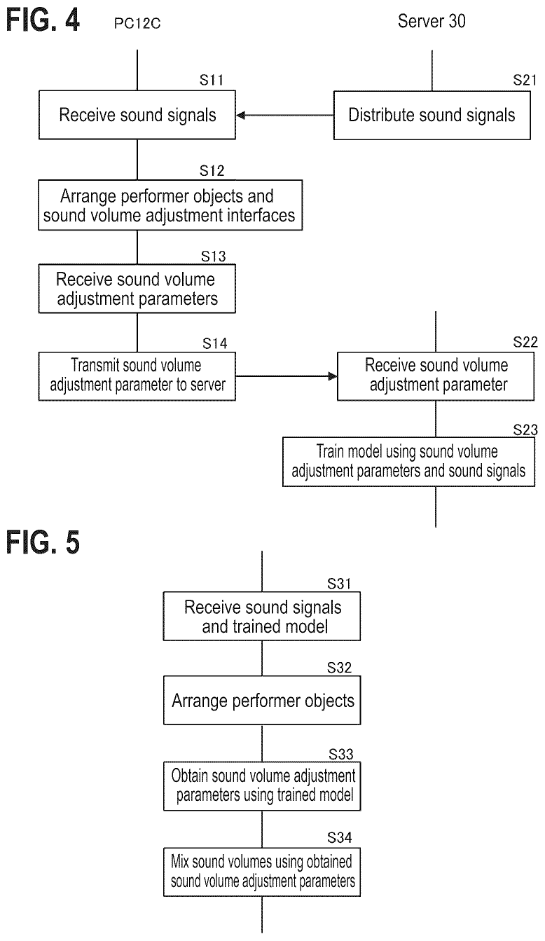

FIG. 4 is a flowchart of operations performed by the PC 12C and the server 30 in training stage. The server 30 distributes the first sound signal and the second sound signal (S21). The processor 12 of the PC 12C receives the first sound signal and the second sound signal from the server 30 (S11).

The processor 12 arranges, in the virtual space, objects of the plurality of performers and a plurality of sound volume adjustment interfaces respectively corresponding to the objects of the plurality of performers (S12).

Specifically, as illustrated in FIG. 3, a performer 31 exists in the first venue 3, which is a remote location, and the processor 12 arranges a first object 51 in the virtual three-dimensional space R1. The first object 51 corresponds to the performer 31. Also as illustrated in FIG. 3, a singer 32 exists in the second venue 5, which is another remote location, and the processor 12 arranges a second object 52 in the virtual three-dimensional space R1. The second object 52 corresponds to the singer 32. The processor 12 also arranges a first sound volume adjustment interface 71 and a second sound volume adjustment interface 72 in the virtual three-dimensional space R1. The first sound volume adjustment interface 71 corresponds to the first object 51, and the second sound volume adjustment interface 72 corresponds to the second object 52. In this embodiment, the processor 12 arranges objects and sound volume adjustment interfaces for performers in two venues, the first venue 3 and the second venue 5. The number of venues, however, will not be limited to two. The processor 12 may arrange objects and sound volume adjustment interfaces for performers in a larger number of venues.

Next, the processor 12 receives, from the user of the PC 12C, sound volume adjustment parameters for the plurality of performers. The sound volume adjustment parameters respectively correspond to the plurality of sound volume adjustment interfaces (S13). As illustrated in FIG. 3, the user of the PC 12C performs sound volume adjustment by operating the first sound volume adjustment interface 71 and the second sound volume adjustment interface 72, which are provided in the virtual three-dimensional space R1. In a case that the user of the PC 12C perceives that the performance sound corresponding to the first object 51 is too loud, the user of the PC 12C operates the first sound volume adjustment interface 71 to lower the sound volume. In the example illustrated in FIG. 3, the first sound volume adjustment interface 71 and the second sound volume adjustment interface 72 are slider operation pieces. Specifically, in a case that the user of the PC 12C perceives that the performance sound corresponding to the first object 51 is too loud, the user of the PC 12C moves the first sound volume adjustment interface 71 downward. In a case that the user of the PC 12C perceives that the singing sound corresponding to the second object 52 is too low, the user of the PC 12C moves the second sound volume adjustment interface 72 upward to increase the sound volume.

The PC 12C transmits the received sound volume adjustment parameter to the server 30 (S14). The server 30 receives the sound volume adjustment parameter from the PC 12C (S22). While in this example the server 30 receives the sound volume adjustment parameter from the PC 12C, the server 30 receives other sound volume adjustment parameters from a large number of information processors. The server 30 uses the received sound volume adjustment parameters to train a predetermined model to learn a relationship between the sound volume adjustment parameters and sound signals that respectively correspond to the plurality of performers and that have been distributed using a predetermined algorithm (S23).

In this embodiment, there is no limitation to the algorithm to train the predetermined model; it is possible to use any machine training algorithm such as CNN (Convolutional Neural Network) and RNN (Recurrent Neural Network). Examples of the machine training algorithm include supervised training, unsupervised training, semi-supervised training, reinforcement training, inverse reinforcement training, active training, and transfer training. The server 30 may also train the predetermined model using a machine training model such as HMM (Hidden Markov Model) and SVM (Support Vector Machine).

For example, in a case that the sound volume of the performance sound of a particular performer (for example, the performer 31 in the first venue 3) is perceived to be too loud by a large number of viewers, the large number of viewers perform the operation of lowering the sound volume. In this case, the predetermined model is trained to output, to the sound signal of the performance sound from the first venue 3, a sound volume adjustment parameter to lower the sound volume. In this manner, the sound signals associated with the plurality of performers are correlated with the sound volume adjustment parameters. Thus, the server 30 trains a predetermined model to learn a relationship between the sound signals associated with the plurality of performers and the sound volume adjustment parameters, to generate a trained model.

FIG. 5 is a flowchart of operations performed by the PC 12C in execution stage. The processor 12 of the PC 12C receives a first sound signal, a second sound signal, and a trained model from the server 30 (S31). It is to be noted that the trained model may be received in advance, before the first sound signal and the second sound signal are received.

The processor 12 arranges objects of a plurality of performers in a virtual space (S32). Specifically, the processor 12 arranges the first object 51 and the second object 52 in the virtual three-dimensional space R1. In this example, in the execution stage, the processor 12 does not arrange the first sound volume adjustment interface 71 and the second sound volume adjustment interface 72.

The processor 12 obtains sound volume adjustment parameters for the plurality of performers using a trained model (S33). As described above, the trained model is trained to learn a relationship between sound signals associated with the plurality of performers and sound volume adjustment parameters respectively corresponding to the sound signals. Specifically, the processor 12 obtains a first sound volume adjustment parameter and a second sound volume adjustment parameter using the trained model. The first sound volume adjustment parameter corresponds to the first sound signal, which corresponds to the first object 51. The second sound volume adjustment parameter corresponds to the second sound signal, which corresponds to the second object 52.

Based on the first and second sound volume adjustment parameters obtained using the trained model, the processor 12 adjusts and mixes the sound volumes respectively of the first and second sound signals (S34). Specifically, the processor 12 adjusts the sound volume of the first sound signal using the first sound volume adjustment parameter, and adjusts the sound volume of the second sound signal using the second sound volume adjustment parameter. Then, the processor 12 mixes the first sound signal and the second sound signal that have undergone the sound volume adjustment.

Thus, the PC 12C uses a trained model trained using sound volume adjustment parameters received from a plurality of users. Using such model, PC 12C adjusts the sound signals associated with the plurality of performers to an appropriate volume balance and then mixes the sound signals. In this manner, the PC 12C adjusts the sound volumes of the virtual singing or musical performance of the plurality of performers in the virtual three-dimensional space R1 to secure an appropriate balance. For a viewer of the virtual singing or musical performance in the virtual three-dimensional space R1, it is not necessary to adjust the sound volumes to secure an appropriate balance. As a result, the viewer is able to enjoy an enhanced customer experience by easily viewing the virtual singing or musical performance in a virtual space at an improved volume balance.

In this example, in the execution stage, the processor 12 does not arrange the first sound volume adjustment interface 71 and the second sound volume adjustment interface 72. It is possible, however, to arrange the first sound volume adjustment interface 71 and the second sound volume adjustment interface 72. In this case, the user of the PC 12C is able to more finely adjust the first sound volume adjustment parameter and the second sound volume adjustment parameter obtained by the processor 12 using the trained model. The PC 12C may also transmit the finely adjusted sound volume adjustment parameters to the server 30. Using the finely adjusted sound volume adjustment parameters, the server 30 may re-train the trained model. As a result, the sound volume adjustment parameters are updated in accordance with the progression of the performance in the virtual three-dimensional space R1. This enables the viewer to experience the performance in the virtual three-dimensional space R1 with a continually adjusted, optimal volume balance that aligns with the progression of the performance, enhancing the overall customer experience.

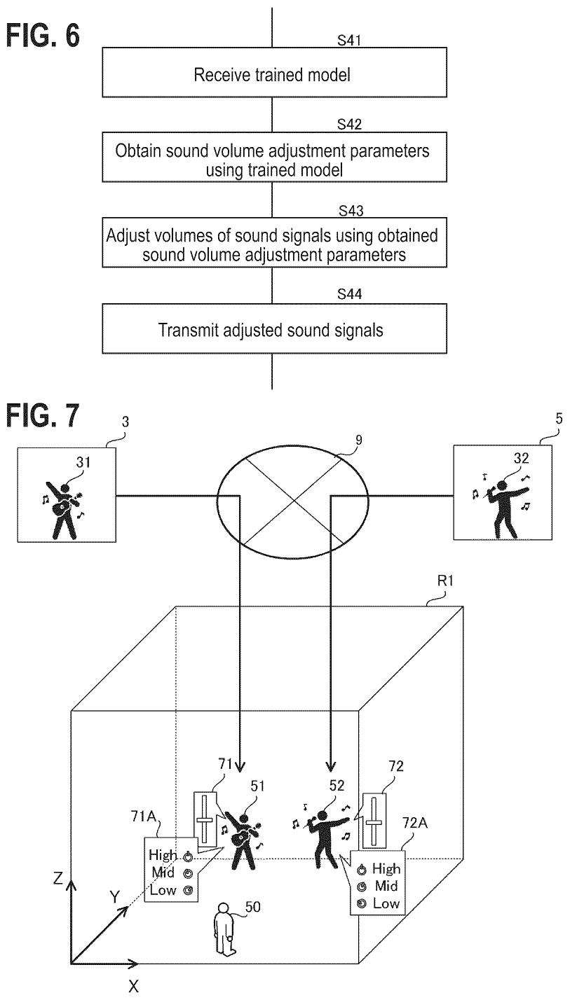

FIG. 6 is a flowchart of operations performed by the PC 12A (or the PC 12B) according to modification 1.

In the above-described embodiment, the PC 12C receives a trained model from the server 30, adjusts the sound volume of the first sound signal using the first sound volume adjustment parameter, adjusts the sound volume of the second sound signal using the second sound volume adjustment parameter, and mixes the first sound signal and the second sound signal that have undergone sound volume adjustment. That is, the sound volume adjustment parameters obtained using the trained model are sound volume adjustment parameters used in a reception-side appliance that mixes the plurality of received sound signals.

In the sound processing system 1 according to modification 1, each of the PC 12A and the PC 12B, which are transmission-side appliances, receives a trained model, adjusts the sound volume of the first sound signal using the first sound volume adjustment parameter, and adjusts the sound volume of the second sound signal using the second sound volume adjustment parameter.

Specifically, the PC 12A, first, receives a trained model from the server 30 (S41). The PC 12A uses the received trained model to obtain a sound volume adjustment parameter of a sound signal to be transmitted (S42). As described above, the trained model is trained to learn a relationship between the sound signals associated with the plurality of performers and sound volume adjustment parameters respectively corresponding to the sound signals. Thus, the PC 12A is able to obtain, using the trained model, the first sound volume adjustment parameter corresponding to the first sound signal. The PC 12A adjusts the sound volume of the first sound signal based on the first sound volume adjustment parameter obtained using the trained model (S43). The PC 12A transmits the adjusted first sound signal to the server 30 (S44). Similarly, the PC 12B adjusts the sound volume of the second sound signal using the second sound volume adjustment parameter based on the received trained model.

That is, in modification 1, the sound volume adjustment parameters obtained using the respective trained models are sound volume adjustment parameters used in the plurality of appliances respectively used by the plurality of performers. Each of the plurality of appliances adjusts the sound volumes of the plurality of sound signals based on the sound volume adjustment parameters. The reception-side appliance receives and mixes the plurality of sound signals that have undergone the sound volume adjustment at the plurality of appliances.

This configuration provides effects similar to the effects provided by the sound processing system 1 according to the above-described embodiment. Specifically, for a viewer of the virtual singing or musical performance in the virtual three-dimensional space R1, it is not necessary to adjust the sound volumes to secure an appropriate balance. As a result, the viewer is able to enjoy an enhanced customer experience by easily viewing the virtual singing or musical performance in a virtual space at an improved volume balance.

In modification 1, it is the PC 12A (or the PC 12B) that adjusts the sound volumes of the sound signals. Another possible example is that the guitar amplifier 11A adjusts the sound volumes of the sound signals based on a trained model, or the electric guitar 10 adjusts the sound volumes of the sound signals based on a trained model. Another possible example is that the PC 12A obtains a sound volume adjustment parameter associated with the guitar amplifier 11A based on a trained model and inputs the sound volume adjustment parameter into the guitar amplifier 11A so that the guitar amplifier 11A adjusts the sound volumes of the sound signals. Another possible example is that the PC 12A obtains a sound volume adjustment parameter associated with the electric guitar 10 based on a trained model and inputs the sound volume adjustment parameter into the electric guitar 10 so that the electric guitar 10 adjusts the sound volumes of the sound signals.

It is possible to use a trained model that is trained to learn a relationship not associated with sound volume adjustment parameters; specifically, it is possible to use a trained model that is trained to learn a relationship between a plurality of sound signals associated with performers and effect parameters of effect processing performed on the sound signals.

FIG. 7 is a perspective view of an example of the virtual three-dimensional space R1 according to modification 2. Identical reference numerals, characters, or symbols are used for components common with FIG. 3, and these components will not be elaborated upon here.

In training stage, the processor 12 of the PC 12C arranges, in the virtual three-dimensional space R1, objects of a plurality of performers and a plurality of effect adjustment interfaces respectively corresponding to the objects of the plurality of performers. Specifically, as illustrated in FIG. 7, the processor 12 arranges a first effect adjustment interface 71A and a second effect adjustment interface 72A in the virtual three-dimensional space R1. The first effect adjustment interface 71A corresponds to the first object 51, and the second effect adjustment interface 72A corresponds to the second object 52.

In this example, the first effect adjustment interface 71A and the second effect adjustment interface 72A are operation pieces for adjusting effect parameters of an equalizer. The first effect adjustment interface 71A and the second effect adjustment interface 72A each include operation pieces for adjusting the levels of the high (High), mid (Mid), and low (Low) tonal ranges.

The user of the PC 12C operates the first effect adjustment interface 71A and the second effect adjustment interface 72A to adjust the effect parameters.

The PC 12C transmits the received effect parameters to the server 30. The server 30 receives effect parameters from a large number of information processors, including the PC 12C. The server 30 uses the large number of received effect parameters to train a predetermined model to learn a relationship between effect parameters and sound signals distributed using a predetermined algorithm and respectively connected to a plurality of performers.

In the execution stage, the processor 12 of the PC 12C receives a first sound signal, a second sound signal, and a trained model from the server 30. The processor 12 obtains, using the trained model, effect parameters respectively for the sound signals respectively associated with the plurality of performers. The processor 12 performs effect processing on the plurality of sound signals based on the effect parameters obtained using the trained model. The processor 12 also adjusts and mixes the sound volumes respectively of the plurality of sound signals that have undergone the effect processing.

Thus, the PC 12C according to modification 2 uses a trained model trained with effect parameters received from a plurality of users to perform suitable effect processing on sound signals respectively associated with the plurality of performers and then mix the sound signals. In this manner, the PC 12C appropriately adjusts the sound quality of virtual singing or musical performance performed by the plurality of performers in the virtual three-dimensional space R1. For a viewer of virtual musical performance in the virtual three-dimensional space R1, it is not necessary to adjust the effect parameters. As a result, the viewer is able to enjoy an enhanced customer experience by easily viewing the virtual musical performance in the virtual three-dimensional space R1 at improved sound quality.

It is to be noted that the effects provided by the above-described equalizer are not intended in a limiting sense. Effects may be provided by a compressor or a reverb unit (reverb processor). For example, if the user of the PC 12C perceives a lack of resonance in the performance sound from the first venue 3, the user adjusts the effect parameters to apply strong reverb processing to the performance sound from the first venue 3. The server 30 receives effect parameters from a large number of information processors, including the PC 12C, and generates a trained model that applies strong reverb processing to the performance sound from the first venue 3. Thus, strong reverb processing is automatically applied to the performance sound from the first venue 3. This makes it unnecessary for the viewer to adjust the effect parameters again to apply strong reverb processing to the performance sound from the first venue 3. As a result, the viewer is able to enjoy an enhanced customer experience by easily viewing the virtual musical performance in the virtual three-dimensional space R1 at improved sound quality.

It is to be noted that the effect processing may not necessarily be performed by a reception-side appliance such as the PC 12C, but may be performed by a transmission-side appliance such as the PC 12A and the PC 12B. The effect processing may also be performed by the guitar amplifier 11A, the electric guitar 10, or the microphone 19. In a case of a transmission-side appliance, the PC 12A and the PC 12B receive a trained model from the server 30, and obtain effect parameters based on the trained model to perform effect processing. In a case of the guitar amplifier 11A, the guitar amplifier 11A may obtain effect parameters based on a trained model to perform effect processing. In a case of the electric guitar 10, the electric guitar 10 may obtain effect parameters based on a trained model to perform effect processing. Another possible example is that the PC 12A obtains, based on a trained model, effect parameters of effect processing for the guitar amplifier 11A and inputs the effect parameters into the guitar amplifier 11A so that the guitar amplifier 11A performs effect processing based on the input effect parameters. Another possible example is that the PC 12A obtains, based on a trained model, effect parameters of effect processing for the electric guitar 10 and inputs the effect parameters into the electric guitar 10 so that the electric guitar 10 performs effect processing based on the input effect parameters.

The sound processing system 1 according to modification 3 obtains information regarding a plurality of audio appliances respectively used by a plurality of performers. Then, based on the obtained information regarding the plurality of audio appliances, the sound processing system 1 according to modification 3 adjusts the effect parameters of effect processing performed on the plurality of sound signals.

For example, the PC 12A transmits information regarding the electric guitar 10 and the guitar amplifier 11A to the server 30. The information regarding the electric guitar 10 and the guitar amplifier 11A includes, for example, model names or serial numbers of the electric guitar 10 and the guitar amplifier 11A Similarly, the PC 12B transmits information regarding the microphone 19 to the server 30, and the PC 12C transmits information regarding the headphone 20 to the server 30.

The server 30 stores a table of information regarding the plurality of audio appliances and equalization effect parameters and other effect parameters respectively suitable for the audio appliances. The server 30 retrieves, from the table, effect parameters corresponding to the audio appliance information received from the PC 12A, the PC 12B, or the PC 12C, and transmits the retrieved effect parameters to the PC 12A, the PC 12B, or the PC 12C.

The PC 12A, the PC 12B, or the PC 12C receives the effect parameters from the server 30 and adjusts effect parameters of effect processing performed on the sound signals of the corresponding audio appliance. For example, based on the effect parameters received from the server 30, the PC 12C adjusts equalizer parameters of the sound signal output to the headphone 20.

This configuration ensures that it is not necessary for the user of each venue to manually adjust the effect parameters of the equalizer of the audio appliance. As a result, the viewer is able to enjoy an enhanced customer experience by easily adjusting to appropriate effect parameters. For example, the sound quality may vary if one performer uses one audio appliance (for example, one microphone) to distribute singing sound, or if the one performer uses another audio appliance (another microphone) to distribute singing sound. Thus, differences in recording environments due to variations in audio appliance may result in differences in the sound quality of the transmitted singing sound. The sound processing system 1 according to modification 3, however, is able to correct such differences in recording environments due to differences in audio appliances.

It is to be noted that the server may obtain effect parameters of the corresponding audio appliance using a model that has been trained to learn a relationship between information regarding the plurality of audio appliances and effect parameters suitable for the respective audio appliances.

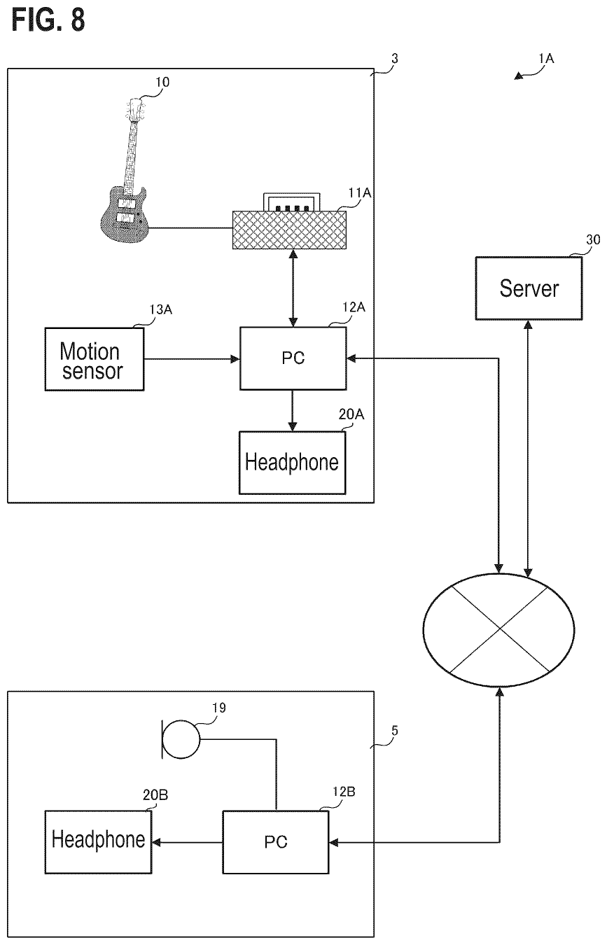

FIG. 8 is a block diagram illustrating a configuration of the sound processing system 1A according to modification 4. Identical reference numerals, characters, or symbols are used for components common with FIG. 1, and these components will not be elaborated upon here. The sound processing system 1A enables the performer in the first venue 3 and the performer in the second venue 5 to play a remote session by mutually transmitting sound signals of performance sound or singing sound.

The PC 12A receives a sound signal of the singing sound of the performer in the second venue 5, adjusts the sound volume of the sound signal, and outputs the resulting sound signal to the headphone 20A. The performer in the first venue 3 listens to the singing sound of the performer in the second venue 5 via the headphone 20A. The performer in the first venue 3 also uses the PC 12A to adjust the sound volume of the singing sound of the performer in the second venue 5, and conducts a musical performance in alignment with the singing sound. The PC 12B receives a sound signal of the performance sound of the performer in the first venue 3, adjusts the sound volume of the sound signal, and outputs the resulting sound signal to the headphone 20B. The performer in the second venue 5 listens to the performance sound of the performer in the first venue 3 via the headphone 20B. The performer in the second venue 5 also uses the PC 12B to adjust the sound volume of the performance sound of the performer in the first venue 3, and conducts a musical performance in alignment with the performance sound.

The server 30 receives sound volume adjustment parameters respectively adjusted at the PC 12A and the PC 12B and trains a predetermined model. This enables the server 30 to generate a trained model trained for the intended musical band. In a case that members of the band play a remote session, the members use an information processor to receive the trained model from the server 30 and adjust sound volume using the trained model.

With this configuration, it is not necessary for the performers using the PC 12A and the PC 12B to adjust the sound volume. As a result, the performers are able to enjoy an enhanced customer experience by playing a remote session with a sound volume appropriately adjusted in the past.

It is to be noted that the sound processing system 1A is an example in which the performers play a remote session in the first venue 3 and the second venue 5. The sound processing system 1A, however, is also capable of implementing a remote ensemble in a larger number of venues where sound signals of performance sound or singing sound are transmitted and received and the performers conduct a musical performance in alignment with each other.

The PC 12C according to modification 5 receives a plurality of sound signals based on first position information and second position information. The first position information is regarding objects of a plurality of performers, and the second position information is regarding a viewer. Then, the PC 12C according to modification 5 adjusts and mixes the sound volumes of the sound signals.

For example, the processor 12 of the PC 12C adjusts the sound volumes of a first sound signal and a second sound signal based on: the distance between the first object 51 and the viewpoint position 50 of the user in the virtual three-dimensional space R1; and the distance between the viewpoint position 50 and the second object 52. The processor 12 of the PC 12C increases the sound volume of the sound signal corresponding to the object closer to the viewpoint position 50, and decreases the sound volume of the sound signal corresponding to the object farther away from the viewpoint position 50.

This enables a viewer of the virtual musical performance in the virtual three-dimensional space R1 to experience a sense of spatial awareness regarding the distance from the performer in the virtual three-dimensional space R1.

The PC 12C according to modification 6 performs sound processing with the viewpoint position 50 as a listening point based on the viewpoint position 50, the position of the first object 51, and the position of the second object 52. An example of the sound processing with the viewpoint position 50 as a listening point is localization processing.

For example, the processor 12 of the PC 12C performs localization processing to position the sound of the first object 51 and the sound of the second object 52 respectively at the position of the first object 51 and the position of the second object 52, as viewed from the viewpoint position 50.

For example, the processor 12 performs localization processing based on HRTF (Head-Related Transfer Function). The HRTF represents a transfer function from a given virtual sound source location to the user's right and left ears. For example, as illustrated in FIG. 3, the position of the first object 51 is to the front left as viewed from the viewpoint position 50. The processor 12 performs binaural processing on the sound signal corresponding to the first object 51 by convolving an HRTF that positions the sound to a front-left position relative to the user. This enables the user of PC 12C to perceive the sound as if listening to the sound of the first object 51 from the front-left position while the user is located at the viewpoint position 50 in the virtual three-dimensional space R1.

In the above-described embodiment, in the training stage, the server 30 receives sound volume adjustment parameters from a large number of information processors, and trains a predetermined model using the sound volume adjustment parameters. Another possible example is that the server 30 receives sound volume adjustment parameters from a single information processor and trains a predetermined model using the sound volume adjustment parameters. For example, in a case that a skillful operation piece adjusts sound volumes to change the balance, the server 30 generates a trained model trained to learn the sound volume adjustment performed by the skillful operation piece, and distributes the trained model. This ensures that the trained model is shared among the large number of information processors. The other information processors adjust the sound volumes using the distributed trained model.

With this configuration, it is not necessary for a viewer of virtual musical performance in the virtual three-dimensional space R1 to adjust the sound volumes to secure a balance. As a result, the viewer is able to enjoy an enhanced customer experience by easily viewing the virtual musical performance with an improved sound volume balance adjusted by a skillful operation piece.

In a case that members of a band play a remote session, the server 30 may receive sound volume adjustment parameters adjusted by the members and train a predetermined model using the received sound volume adjustment parameters. This enables the server 30 to generate a trained model trained for the band. In a case that members of the band play a remote session, the members use an information processor to receive the trained model from the server 30 and adjust sound volume using the trained model.

With this configuration, it is not necessary for the band members who play a remote session to adjust the sound volumes to secure an appropriate balance. As a result, the band members are able to enjoy an enhanced customer experience by playing a remote session at an improved sound volume balance adjusted in the past.

It is to be noted that the server 30 may re-train a trained model that has been trained using sound volume adjustment parameters received from a single information processor. The server 30 may re-train the trained model using sound volume adjustment parameters received again from the single information processor, or may re-train the trained model using sound volume adjustment parameters received from another information processor.

The user may input sound volume adjustment parameters through voice commands, such as “increase the volume of the first performer”, instead of using an operation piece such as a slider.

An administrator of the sound processing system including the server 30 may not only provide a performance environment in the virtual three-dimensional space R1 but also sell a trained model. For example, the server 30 may perform billing processing for a particular trained model and enable downloading of the trained model after payment confirmation. The billing processing may be performed by a billing-dedicated server different from the server 30. For example, the server 30 charges a specified amount to a user and then allows the user to download a trained model trained using volume adjustment operations performed by a skilled operator. In this case, the server 30 may perform payment processing to compensate the skilled operator each time the trained model is downloaded. In this manner, the administrator of the sound processing system including the server 30 may provide incentives to the operator. This enables the operator to monetize the operator's volume adjustment expertise. Therefore, the administrator can increase motivation for a large number of users to utilize the sound processing system.

It is to be noted that the server 30 may accumulate and retain a plurality of trained models trained using sound volume adjustment parameters provided by a plurality of human operators. When a viewer specifies a trained model from among the plurality of trained models, the server 30 causes the information processor used by the viewer to download the specified trained model. In this case, the server 30 may perform processing of paying compensation to the operator who trained the downloaded trained model. This enables the administrator to enhance the motivation of a large number of human operators to use the sound processing system.

It is to be noted that the billing processing may be structured as a monthly or annual subscription rather than a per-download charge.

As used herein, the term “computer system” is intended to encompass home-page providing environments (or home-page display environments) insofar as the WWW (World Wide Web) is used. Also as used herein, the term “computer readable recording medium” is intended to mean: a transportable medium such as a flexible disk, a magneto-optical disk, a ROM (Read Only Memory), a CD-ROM (Compact Disk Read Only Memory); and a storage device such as a hard disk incorporated in a computer system. Also as used herein, the term “computer readable recording medium” is intended to encompass a recording medium that holds a program for a predetermined time period. An example of such recording medium is a volatile memory inside a server computer system or a client computer system.

It will also be understood that the program may implement only some of the above-described functions, or may be combinable with a program(s) recorded in the computer system to implement the above-described functions. It will also be understood that the program may be stored in a predetermined server, and that in response to a demand from another device or apparatus, the program may be distributed (such as by downloading) via a communication line.

While embodiments of the present disclosure have been described in detail by referring to the accompanying drawings, the embodiments described above are not intended as limiting specific configurations of the present disclosure, and various other designs are possible without departing from the scope of the present disclosure.

What is claimed is:

1. A method of processing sound, the method comprising:
arranging objects of a plurality of performers in a virtual space;
receiving a plurality of sound signals respectively corresponding to the plurality of performers;
obtaining, using a trained model, sound volume adjustment parameters respectively for the plurality of performers, the trained model being trained to learn a relationship between each sound signal, among the plurality of sound signals, that corresponds to each performer of the plurality of performers and each sound volume adjustment parameter, among the sound volume adjustment parameters, that corresponds to the each sound signal; and
adjusting and mixing sound volumes respectively of the plurality of sound signals based on the sound volume adjustment parameters obtained using the trained model.

2. The method according to claim 1, further comprising:
arranging, in the virtual space, a plurality of sound volume adjustment interfaces respectively corresponding to the objects of the plurality of performers;
receiving the plurality of sound signals respectively corresponding to the plurality of performers;
receiving, from the user, sound volume adjustment parameters respectively for the plurality of performers and respectively corresponding to the plurality of sound volume adjustment interfaces; and
generating the trained model trained to learn a relationship between the each sound signal corresponding to the each performer and each sound volume adjustment parameter, among the sound volume adjustment parameters received from the user, that corresponds to the each sound signal.

3. The method according to claim 1, wherein
the trained model is trained to learn a relationship between the each sound signal and an effect parameter of effect processing performed on the each sound signal, and
the method also comprises
obtaining, using the trained model, effect parameters respectively for the plurality of performers, and
performing the effect processing on the plurality of sound signals based on the effect parameters obtained using the trained model.

4. The method according to claim 3, further comprising:
receiving information regarding a plurality of audio appliances respectively used by the plurality of performers; and
obtaining the effect parameters respectively for the plurality of performers based on the received information.

5. The method according to claim 1, further comprising:
obtaining information regarding a plurality of audio appliances respectively used by the plurality of performers; and
adjusting the sound volumes respectively of the plurality of sound signals based on the obtained information.

6. The method according to claim 1, further comprising:
obtaining first position information regarding positions respectively of the objects of the plurality of performers and second position information regarding a position of a viewer; and
adjusting the sound volumes respectively of the plurality of sound signals based on the first position information and the second position information.

7. The method according to claim 1, wherein the user comprises a performer.

8. The method according to claim 1, wherein the sound volume adjustment parameters obtained using the trained model are used in a reception-side appliance configured to mix the plurality of received sound signals.

9. The method according to claim 1, wherein
the sound volume adjustment parameters obtained using the trained model are respectively used in a plurality of appliances respectively used by the plurality of performers,
the plurality of appliances are configured to adjust the sound volumes respectively of the plurality of sound signals based on the sound volume adjustment parameters, and
a reception-side appliance is configured to receive and mix the plurality of sound signals whose sound volumes have been adjusted by the plurality of appliances.

10. The method according to claim 1, wherein the plurality of sound signals respectively corresponding to the plurality of performers are received via a network.

11. The method according to claim 1, further comprising:
receiving the sound volume adjustment parameters from a first information processor of a first user;
training a predetermined model using the sound volume adjustment parameters to generate the trained model;
transmitting the trained model to a second information processor of a second user; and
obtaining, using the second information processor, the sound volume adjustment parameters using the trained model.

12. The method according to claim 11, further comprising:
receiving the sound volume adjustment parameters from the first information processor or the second information processor; and
re-training the trained model using the received sound volume adjustment parameters.

13. The method according to claim 11, further comprising:
performing, using a server, billing processing for the second user; and
performing, using the server, compensation payment processing for the first user.

14. A sound processing apparatus comprising:
a processor configured to:
arrange objects of a plurality of performers in a virtual space;
receive a plurality of sound signals respectively corresponding to the plurality of performers;
obtain, using a trained model, sound volume adjustment parameters respectively for the plurality of performers, the trained model being trained to learn a relationship between each sound signal, among the plurality of sound signals, that corresponds to each performer of the plurality of performers and each sound volume adjustment parameter, among the sound volume adjustment parameters, that corresponds to the each sound signal; and
adjust and mix sound volumes respectively of the plurality of sound signals based on the sound volume adjustment parameters obtained using the trained model.

15. The sound processing apparatus according to claim 14, further configured to:
arrange, in the virtual space, a plurality of sound volume adjustment interfaces respectively corresponding to the objects of the plurality of performers;
receive the plurality of sound signals respectively corresponding to the plurality of performers;
receive, from the user, sound volume adjustment parameters respectively for the plurality of performers and respectively corresponding to the plurality of sound volume adjustment interfaces; and
generate the trained model trained to learn a relationship between the each sound signal corresponding to the each performer and each sound volume adjustment parameter, among the sound volume adjustment parameters received from the user, that corresponds to the each sound signal.

16. A non-transitory computer-readable storage medium storing a program which, when executed by at least one processor, causes the at least one processor to:
arrange objects of a plurality of performers in a virtual space;
receive a plurality of sound signals respectively corresponding to the plurality of performers;
obtain, using a trained model, sound volume adjustment parameters respectively for the plurality of performers, the trained model being trained to learn a relationship between each sound signal, among the plurality of sound signals, that corresponds to each performer of the plurality of performers and each sound volume adjustment parameter, among the sound volume adjustment parameters, that corresponds to the each sound signal; and
adjust and mix sound volumes respectively of the plurality of sound signals based on the sound volume adjustment parameters obtained using the trained model.

17. The non-transitory computer-readable storage medium according to claim 16, wherein the at least one processor is further caused to:
arrange, in the virtual space, a plurality of sound volume adjustment interfaces respectively corresponding to the objects of the plurality of performers;
receive the plurality of sound signals respectively corresponding to the plurality of performers;
receive, from the user, sound volume adjustment parameters respectively for the plurality of performers and respectively corresponding to the plurality of sound volume adjustment interfaces; and
generate the trained model trained to learn a relationship between the each sound signal corresponding to the each performer and each sound volume adjustment parameter, among the sound volume adjustment parameters received from the user, that corresponds to the each sound signal.

18. The method according to claim 2, wherein
the trained model is trained to learn a relationship between the each sound signal and an effect parameter of effect processing performed on the each sound signal, and
the method also comprises
obtaining, using the trained model, effect parameters respectively for the plurality of performers, and
performing the effect processing on the plurality of sound signals based on the effect parameters.

19. The method according to claim 2, further comprising:
obtaining information regarding a plurality of audio appliances respectively used by the plurality of performers; and
adjusting the sound volumes respectively of the plurality of sound signals based on the obtained information.

20. The method according to claim 3, further comprising:
obtaining information regarding a plurality of audio appliances respectively used by the plurality of performers; and
adjusting the sound volumes respectively of the plurality of sound signals based on the obtained information.
